(19) United States
(12) Patent Application Publication
(10) Pub. No.: US 2018/0313386 A1
(43) Pub. Date: Nov. 1, 2018

(54) FASTENING ELEMENT AND METHOD FOR FASTENING GUARD ELEMENTS ON A SUBSTRUCTURE

(71) Applicant: Meiser Vogtland OHG, Oelsnitz (DE)

(72) Inventor: Wolfgang MEISER, Saarbruecken (DE)

(73) Assignee: Meiser Vogtland OHG, Oelsnitz (DE)

(21) Appl. No.: 15/580,924

(22) PCT Filed: Jun. 10, 2016
(86) PCT No.: PCT/DE2016/100264

§ 371 Date: Dec. 8, 2017

(30) Foreign Application Priority Data
Jun. 18, 2015 (DE) 20 2015 103 230.7

(51) Int. Cl. F16B 19/14; F16B 5/02

(52) U.S. Cl. CPC F16B 19/14; F16B 5/02

(57) ABSTRACT

The present invention relates to a fastening element and a method for fastening guard elements on a substructure. In order to provide an improved fastening element for fastening guard elements, it is suggested within the scope of the invention that the fastening element consists of a shot-fire element and a collar screw connection, wherein the shot-fire element has a tip and a body with an external thread, and the collar screw connection has a blind hole with an internal thread that corresponds to the external thread of the shot-fire element, thereby enabling the shot-fire element to be connected to the collar screw connection. The guard elements, which have a circumferential collar, are placed on a substructure, in particular a steel structure such as a double-T beam, and subsequently anchored by means of fastening elements. For this purpose, the shot-fire element is fired into the substructure (steel substructure) by means of a stud gun such that the tip penetrates into the substructure. This results in a form-locked and captive connection between the shot-fire element and the substructure.

The present invention relates to a fastening element and a method for fastening guard elements on a substructure.

Guard elements are used to cover large surface areas, e.g. false ceilings, for delimiting platform edges and for housing materials handling equipment.

They consist of a load-bearing tubular frame and a welded-on mesh grating.

The prior art discloses guards fastened to an existing steel structure, for example double-T beams, by means of
U-bolts
drilling screws
retaining bars and
shot-fire elements combined with conventional sleeve nuts.

The fastening variants listed have disadvantages.

The use of U-bolts, for example, is considerably time-consuming. Furthermore, accessibility from below has to be ensured by means of hoisting platforms. This is often difficult on account of already existent building installations, incurring considerable additional costs and making coordination more difficult for the technician carrying out the work.

Where drilling screws are used for fastening purposes, there is no necessity for accessibility from below. However, a blind hole has to be made in the steel structure as a basic pre-requisite for later insertion of the drilling screw. Chips are produced during the making of this hole with a conventional steel bit, and these chips fall to the level below. Highly sensitive technology (robot technology, for example) housed in the level below may get damaged by these chips.

Chips are also produced when retaining bars are used as fasteners (during the fastening process). The fastening process itself, moreover, is complicated to perform.

Power actuated studs combined with conventional sleeve nuts can be driven in from above without the formation of drill chips. Under load and with the associated permissible bending of the guard element, however, transverse forces are introduced into the power actuated studs and may cause them to shear off. This leads to loss of fixation of the guard element, which is, however, essential for reasons of safety.

The aim of the invention claimed, therefore, is to provide a fastening element for fastening guard elements, which does not have the disadvantages set forth above.

According to the invention, this aim is achieved for a fastening element for fastening guard elements on a substructure in that the fastening element consists of a shot-fire element and a collar screw connection, wherein the shot-fire element has a tip and a body with an external thread, and the collar screw connection has a blind hole with an internal thread that corresponds to the external thread of the shot-fire element, thereby enabling the shot-fire element to be connected to the collar screw connection.

The guard elements, which have a circumferential collar, are placed on a substructure, in particular a steel structure such as a double-T beam, and subsequently anchored by means of fastening elements.

For this purpose, the shot-fire element is fired into the substructure (steel substructure) by means of a stud gun such that the tip penetrates into the substructure.

This results in a form-locked and captive connection between the shot-fire element and the substructure.

Upward of its tip, the shot-fire element has an external thread which is connected, i.e. twisted together, with the corresponding internal thread of the collar screw connection.

Use of a fastening element of this kind is advantageous because no chips are produced during the fastening process. In addition, driving in the shot-fire element with the stud gun provided for this purpose is considerably less time consuming than the customary known drilling process. Furthermore, there is no necessity for accessibility from the underlying level.

For various reasons, assembling and disassembling the collar screw connection may be difficult (due to overloading, a deformed guard element or incorrect placing of the shot-fire element.

An embodiment of the invention therefore provides for the collar screw connection to be of tapered configuration in the end portion opposite the end with the blind-hole opening.

So as to always ensure easy assembly and disassembly by means of conventional and generally available technology, provision may also be made for the taper in the end portion opposite the end with the blind hole opening (upper portion of the collar screw connection) to be of chamfered configuration.

On account of the chamfering, the effective diameter at the upper end of the collar screw connection is reduced.

It is within the scope of the invention for the collar screw connection to have, in the end portion opposite the blind-hole opening, a tool engagement feature enabling the internal thread of the collar screw connection to be twisted, i.e. screwed together with the external thread of the shot-fire element.

This makes it possible to tighten or release the connected components (shot-fire element and collar screw connection) non-destructively at any time.

According to this embodiment of the invention, provision may advantageously be made for the tool-engagement feature to be configured as a hexagon socket.

This shape enables time-saving connection of the collar screw connection with the shot-fire element using conventional, generally available technology.

So as to ensure that the shot-fire element is driven to a pre-determined depth into the substructure, the invention provides for the shot-fire element to have a distance element in the area of its tip. The distance element is configured in such a way that it extends radially beyond the tip of the shot-fire element. The distance element may take the form of a plastic ring, for example, that has been pre-fitted onto the shot-fire element.

The invention also provides advantageously for the collar screw connection to have, on its outside, a circumferential shoulder which is configured such that the end of the collar screw connection nearer to the blind-hole opening has a tapered diameter.

If the guard element bends, the guard element, which has a drill hole at the bottom, is pulled, with this drill hole, up against the shoulder of the collar screw connection.

By virtue of the collar screw connection's shoulder, exclusively longitudinal forces act on the shot-fire element. As a result, any occurrence of transverse forces can be minimized or precluded, and destruction of the shot-fire element caused by the occurrence of transverse forces reduced or prevented.

An embodiment of the invention provides for a damping element to be located in the area of the collar screw connection's shoulder.

To minimize the noise of the shoulder banging against the collar of the guard element's lower drill hole, a damping element is located on the stepped shoulder (collar) of the collar screw connection. The damping element may be a noise-muffling rubber ring, for example, which encircles the collar screw connection.

The scope of the invention includes a method for fastening guard elements on a substructure and comprising the following steps:
Placing the guard element, which consists of a load-bearing tubular frame and a wire grating welded thereon and which has, in the corner areas of the tubular frame, two mutually aligned drill holes, the lower of which has a smaller diameter than the upper drill hole, on the substructure;
Connecting the tip of the shot-fire element with the substructure in form-locking manner by actuating a stud gun;
Inserting a collar screw connection through the upper drill hole and screwing the internal thread of the collar screw connection and the external thread of the shot-fire element together.

To reduce the noise, a rubber ring serving as a damping element is advantageously pushed onto the stepped collar of the collar screw connection prior to screwing the internal thread of the collar screw connection and the external thread of the shot-fire element together.

Illustrative embodiments of the invention, which is not limited to these, are explained below in more detail by reference to drawings. The drawing in

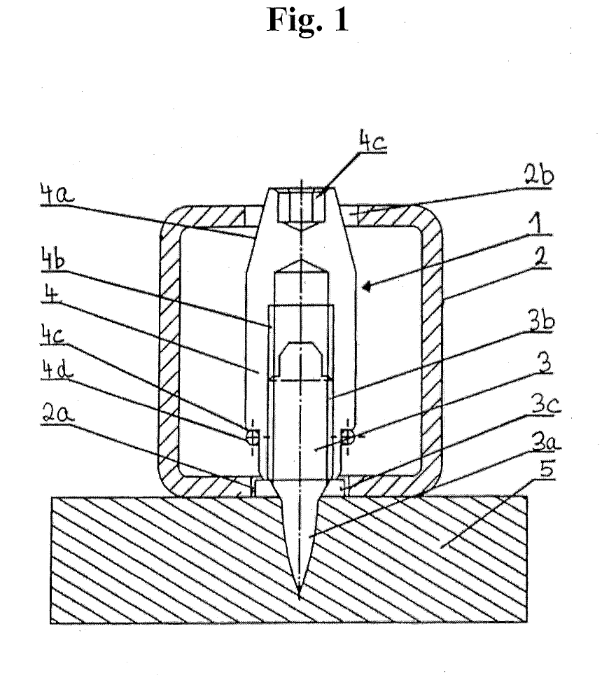

FIG. 1 is a sectional view of a fastening element, which fastens a guard element to a substructure;

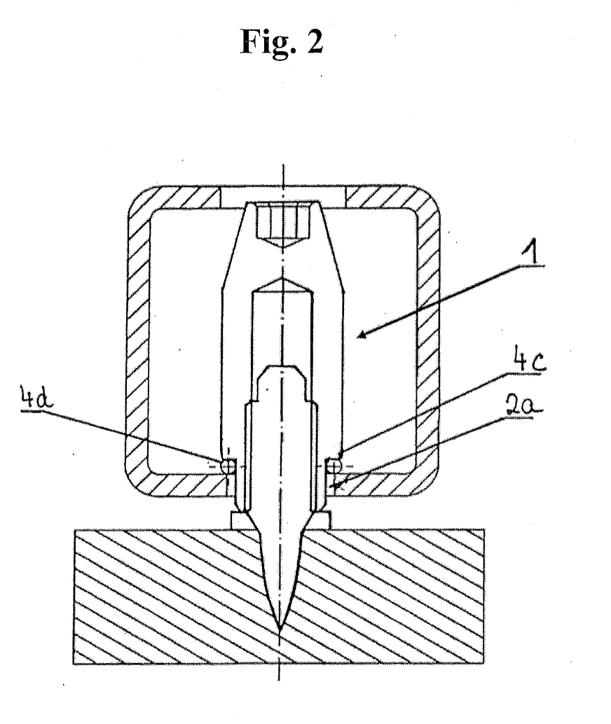

FIG. 2 is a sectional view of a fastening element, which fastens a loaded and bent guard element to a substructure.

As shown in FIG. 1, the guard element 2 is disposed on a substructure 5 and is fastened thereto by way of a fastening means 1 according to the invention. In the example shown, the substructure is a steel substructure.

Each guard element 2, consisting of a load-carrying tubular frame and a wire grating, has two mutually aligned drill holes 2a, 2b in the four corner areas of the tubular frame. The lower drill hole 2a has a smaller diameter than the upper drill hole 2b.

During installation of the shot-fire element 3 the necessary stud gun is inserted into the two drill holes 2a, 2b, thereby ensuring that the shot-fire element 3 and the two drill holes 2a, 2b are centered relative to one another. The tip 3a of the shot-fire element 3 is connected in form-locked and captive manner with the steel substructure 5 by actuating the stud gun. By virtue of a distance element 3a, every shot-fire element 3 penetrates to a defined depth.

The collar screw connection 4 is inserted through the upper drill hole 2b and is screwed together with the shot-fire element using familiar technology. The origin of force here is the hexagon socket 4e in the collar screw connection 4, with the external thread 4b of the shot-fire element 4 and the internal thread 3b of the collar screw connection 3 being in mutual engagement.

A chamfer at the upper end 4a of the collar screw connection 4 facilitates assembly or disassembly.

So as to ensure that the shot-fire element 3 is driven into the substructure 5 to a pre-determined depth, the invention provides for the shot-fire element 3 to have a distance element 3c in the area of its tip 3c. The diameter of the distance element 3c is smaller than the diameter of the lower drill hole 2a of the tubular frame of the guard element 2.

FIG. 2 shows that a load on the guard matting 2 causes the guard matting 2 to bend. This leads to lifting of the corner areas.

The lower drill hole 2a of the guard element 2 is pulled up against the shoulder (stepped collar) 4c of the collar screw connection. The advantage of designing the fastening element 1 in this way is that exclusively tensile forces act on the shot-fire element, thereby practically ruling out any risk of destruction due to the influence of transverse forces.

So as to minimize the noise generated by the mutual impact—caused by a load on the guard element—of the shoulder 4c and the collar of the lower drill hole 2a, a rubber ring 4d serving as damping element may be pushed onto the stepped collar (shoulder) 4c.

The general part of the description may be referred to in respect of further features not shown in the drawings.

To conclude, it is pointed out that the teaching of the invention is not limited to the illustrative embodiments described above.

1-10. (canceled)

11. A combination of a fastening element and a guard element for the purpose of fastening guard elements on a substructure, wherein the fastening element consists of a shot-fire element and a collar screw connection, wherein the shot-fire element comprises a tip and a body with an external thread and the collar screw connection has a blind hole with an internal thread that corresponds to the external thread of the shot-fire element, thereby enabling the shot-fire element to be connected to the collar screw connection, and wherein the collar screw connection has, in an end portion opposite a blind-hole opening, a tool-engagement feature enabling the internal thread of the collar screw connection and the external thread of the shot-fire element to be twisted together, wherein the guard element consists of a load-bearing tubular frame and a wire grating welded thereon, whereby two mutually aligned drill holes are provided in the corner areas of the tubular frame, a lower of which has a smaller diameter than the upper drill hole, and the collar screw connection of the fastening element having, on its outside, a circumferential shoulder which is configured such that the end of the collar screw connection nearer to the blind-hole opening has a tapered diameter and, if the guard element bends, the collar of the lower drill hole makes contact with the shoulder.

12. The combination according to claim 11, wherein the collar screw connection is of tapered configuration in the end portion opposite the blind-hole opening.

13. The combination according to claim 12, wherein the taper in the end portion opposite the blind-hole opening is of chamfered configuration.

14. The combination according to claim 11, wherein the tool-engagement feature is configured as a hexagon socket.

15. The combination according to claim 11, wherein the shot-fire element has a distance element in the area of its tip.

16. The combination according to claim 11, wherein a damping element is located in the area of the shoulder of the collar screw connection.

17. A method for fastening guard elements on a substructure, comprising the following steps:
placing the guard element on the substructure, the guard element consisting of a load-bearing tubular frame and a wire grating welded thereon, wherein two mutually aligned drill holes are provided in the corner areas of the tubular frame, whereby the lower drill hole has a smaller diameter than the upper drill hole,
connecting the tip of a shot-fire element with the substructure in form-looking manner by actuating a stud gun;
inserting a collar screw connection through an upper drill hole and screwing the internal thread of the collar screw connection and the external thread of the shot-fire element together.

18. The method according to claim 17, wherein a rubber ring serving as damping element is pushed onto a shoulder of the collar screw connection prior to screwing the internal thread of the collar screw connection and the external thread of the shot-fire element together.
